(19) United States
(12) Patent Application Publication
(10) Pub. No.: US 2002/0124206 A1
(43) Pub. Date: Sep. 5, 2002

(54) Checking a computer system for blocked memory areas after termination of a process

(75) Inventor: Norbert Frisch, Marunsried (DE)

Correspondence Address: STAAS & HALSEY LLP, 700 11TH STREET, NW, SUITE 500, WASHINGTON, DC, 20001, US

(73) Assignee: Siemens Aktiengesellschaft, Munich (DE)

(21) Appl. No.: 10/086,712

(22) Filed: Mar. 4, 2002

(30) Foreign Application Priority Data
Mar. 2, 2001 (EP) 01105177.8

(51) Int. Cl. G06F 11/07

(52) U.S. Cl. 714/34

(57) ABSTRACT

A method and an apparatus check a computer system for blocked or incorrectly allocated memory areas, which can arise as a result of termination of a process which accesses the memory in addition to other processes. This is checked by recording a first state vector before the start of the process and a second state vector describing the state of the memory after termination. The two state vectors are then compared for a match.

### CROSS REFERENCE TO RELATED APPLICATIONS

This application is based on and hereby claims priority to European Application No. 01105177.8 filed on Mar. 2, 2001, the contents of which are hereby incorporated by reference.

### BACKGROUND OF THE INVENTION

The invention is in the field of computer systems and relates to the assignability of operating means, in particular of memory resources, after termination of a process.

The invention relates, in particular, to a method for checking the freely assignable or freely available operating means accessed by a plurality of processes after termination of a process and possibly for restoring an initial state of the operating means before termination.

A computer system has a plurality of operating means available which can be accessed by a respective plurality of processes. Operating means are, by way of example: memory, computer core, bandwidth of a data transmission channel, peripherals, files etc. The processes compete for shared operating means. Access to these operating means is therefore subject to certain restrictions. To ensure the best possible execution of the processes, it is necessary to ensure that at any time the greatest possible scope of an operating means—e.g. of a memory—is freely available or can be assigned to a process.

If various applications are running on a system, one of these applications can crash. Since a process or an application is virtually always accessing particular operating means, in particular memory resources, unintentional termination of the application can mean that the resources nevertheless remain in use, despite the process having been interrupted or having stopped, and are therefore not available further for the other processes. This reduces the performance level of the system and, particularly if these events cumulate, can result in considerable restrictions until the whole system stops.

To date, the whole system has always been rebooted when an application process has crashed in order to be able to ensure that the operating system resets the operating means to their initial state again, in particular that the memory areas are made available again.

This practice is found to be disadvantageous for a number of reasons. First, it is very time-consuming, since all the other processes need to be terminated, and it is necessary to wait until the operating system reboots. Secondly, it is necessary to stop processes which are time-critical, for example, and permit interruption only with errors. Furthermore, it has not been possible to date to obtain information regarding whether any blocked memory areas have actually arisen as a result of the application's crashing. This is because in the cases in which no blocked or locked memory areas have arisen, it is sufficient to restart just the application. Instead, the shared operating means need to be examined with regard to their availability, however.

Previously, if the whole system was not booted after termination of application software, then there was the risk that the crash resulted in lost system resources, and that, by way of example, a blocked memory area allocated to the application existed which could no longer be used after the software had crashed, however. This can occur, among other things, in the case of memory allocation performed during the execution time of a program, for example by virtue of data becoming unobtainable if there is no longer a pointer referring to them. This can consequently result in less and less freely available memory space being available and, in the worst case, the limits of the virtual memory being exceeded. If this resource problem is not eliminated, it can cause serious consequential errors.

U.S. Pat. No. 6,097,393 describes a method which is likewise in the field of resource management. It discloses a method which is based on a three-dimensional representation of the resources which is intended to facilitate navigation and management of the resources for a user. However, this method relates to error-free running of the system and makes no suggestions as regards the practice in the event of incorrectly allocated memory resources which have arisen on account of termination of a process.

### SUMMARY OF THE INVENTION

It is therefore a potential object to provide a method which, following termination or a crash by at least one process, automatically records the state of the operating means, in particular of the memory, and analyzes whether starting the process is sufficient to transform the state of the operating means into the state which existed before the crash.

Another potential object is to transfer the system, after termination of at least one process, efficiently and automatically to a state in which all the operating means are available to the extent they were before termination, in particular freely available.

A method for ascertaining an assignability for at least one operating means in a computer system after at least one process accessing the operating means in the system has stopped, has the following steps:

a first state vector for the operating means is ascertained before the process is put into operation,

a second state vector for the operating means is ascertained after the process has stopped,

the two state vectors are compared for a match in order to ascertain whether the stopping of the process has resulted in all the operating means remaining available and assignable.

This object may also achieved by the use of the method for automatically unblocking the operating means after termination of the process by virtue of the process being rebooted if the two state vectors match and, otherwise, at least one mechanism being started for unblocking or restoring the operating means.

On the basis of an object achieved in accordance with claim 14, the invention provides a]A computer system which is intended for carrying out the method has an operating means checking device which respectively ascertains a state for the operating means before and after a process has been terminated and records whether the termination has resulted in unassignable operating means by comparing the state after termination with the state before termination for discrepancies.

The preferred embodiment relates to a mechanism for identifying freely assignable and blocked memory resources accessed by a user process or an application. If the application has allocated particular memory areas and has crashed on account of an error, this unforeseen termination of the software entails the risk that the allocated memory areas have not been made available again. Since the operating means (memory) is a shared system resource which is accessed by other processes as well, this system resource cannot continue to remain freely available and hence cannot be used for applications which are still running. If such incorrect allocations cumulate, this causes serious losses of efficiency in the whole system and an increased likelihood of errors.

So that such incorrect allocations can be identified, an identification mechanism is provided which compares a first state of the operating means before the application crash (time t1) with a second state of the operating means after this crash (time t2). On the basis of this comparison, conclusions are drawn about locked or blocked memory areas.

The statement regarding whether or not blocked memory areas have arisen as a result of the crash is taken as a basis for selecting further action: if there are blocked memory areas, then another mechanism needs to be activated which makes these blocked areas freely available again. This can be done by algorithms or programs which are known, by way of example, by the term “garbage collection”. Alternatively, the whole system may need to be rebooted in this case. Since this action is very time-consuming, however, it is avoided where possible. In the other case, that is to say if there are no blocked memory areas and hence the state of the memory before the crash matches the state after the crash, it is sufficient—without taking any risks with regard to the operating means—to restart just the application.

To ascertain the system state in terms of the operating means, provision is made for state vectors to be recorded at different times (at least two times t1 and t2), which are then compared for a match. In this case, the state vector records a depiction of one or more operating means for a process to be examined. In the preferred embodiment, it comprises at least the parameters “still freely available memory for the process to be examined” and/or “memory blocked from the process to be examined”. However, it is also possible for just one of the two parameters above to be recorded. Preferably, only the depiction of the memory area whose use is shared (shared memory) is then recorded using the parameters “address”, “size” and “process identification” for the shared memory.

This means that the depictions of the respective relevant operating means to be checked can be compared for a match in order to be able to use this as a basis for deriving a statement regarding whether the initial state of the system has been maintained in terms of the availability of the operating means.

A fundamental aspect of the recording of the state vectors is that they are process-specific; this means that they allow a clear conclusion, in terms of the tied or blocked operating means, about the respectively allocating process. The two state vectors are therefore prevented from delivering a depiction “corrupted” by the activity of background processes. This corrupted depiction could arise in the following case, for instance: if the process which has been “killed” allowed no blocked memory areas to arise, and the two state vectors therefore ought to match, they can nevertheless differ from one another owing to the fact that other background processes are active which are likewise allocating memory areas. In that case, the sum of the allocated memory areas before the crash would differ from the sum of the allocated memory areas after the crash, even though the crash would not be the cause of this discrepancy. This is taken into account by additionally recording, with the state vectors, which process is the origin of the blocked operating means, in particular memory areas. Besides the sum of the allocations of all the active processes, a process-specific depiction is additionally generated as well.

However, the operating means can be formed not only by the memory, but rather, in alternative embodiments, comprises the CPU (if it works as a shared operating means), other peripherals accessed by at least one process, all physical operating means and/or all virtual operating means, etc.

The parameters for the first and/or second state vector(s) are preferably recorded by virtue of an operating system service being tested, or recording is generated from statistical data automatically recorded by the operating system.

In one alternative embodiment, the method is incorporated into an operating system.

Another, preferred embodiment contains a graphical interface displaying the result of the state comparison for the two operating means state vectors. The user then has the opportunity to intervene manually in the method sequence in order to stipulate, for example in predefined cases or exceptional situations, that it is just necessary to start the application, since, by way of example, the used memory areas which have arisen as a result of the “killed” process are so small that they would not justify restarting the whole system.

Alternatively, provision is made for the method to be implemented in a superordinate routine whose task is memory management.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a flowchart for an embodiment of the present invention,

FIG. 2 shows a schematic illustration of component parts of a computer system based on the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

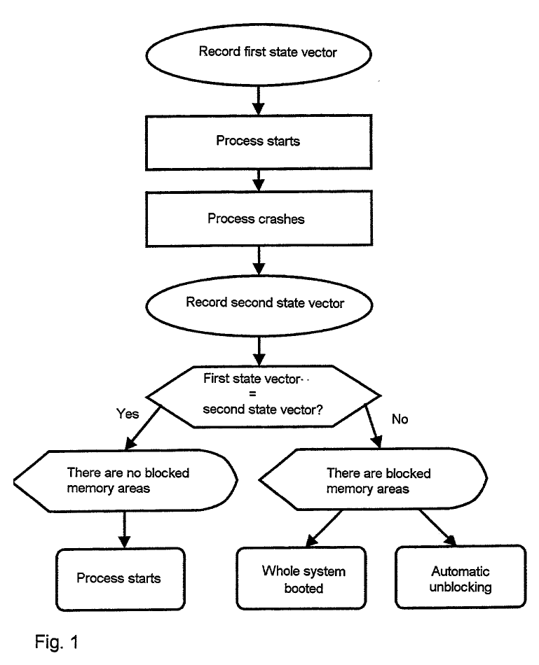

The text below gives a brief introductory description of the basic sequence of the method and then—with reference to FIG. 1—outlines the sequence using a preferred embodiment.

A computer system simultaneously has a plurality of active processes 10—application processes and/or system processes—which access shared operating means 12. In this exemplary embodiment, the operating means 12 relates to the shared memory areas 12. If a process 10 encounters a serious error, this results in termination of the process 10 or in the application crashing. It is now necessary to decide whether it is sufficient to start the process 10 in order to make all the operating means 12 used by this process 10 available again or whether, otherwise, the whole system needs to be fully restarted.

To this end, a first state vector 14 is recorded before the process 10 starts—at time t1—as shown in FIG. 1. The first state vector 14 comprises the following parameters 18 for the memory 12 allocated by the process 10: an address for the memory 12, the size thereof and which process 10 started this memory area.

Next, the process 10 is started. The process 10 runs in the time following a serious error and is terminated: the application crashes.

A second state vector 16 is then—at time t2—recorded which is intended to denote the state of the operating means, in particular of the memory 12, after the process 10 has been terminated. This state vector likewise gives an indication about the number and size of the freely available memory areas and of the allocated memory areas of the processes active at time t2.

Next, the two state vectors 14, 16 can be compared for a match. If there is a match, it is possible to conclude that termination of the application has not changed anything about the initial state of the memory 12 (before the start of the application). It is thus sufficient to restart the application without needing to accept the risk of incorrectly allocated memory. In this case, it is possible to start the application either automatically or after processing an interactive user confirmation.

If, in the other case, there is a discrepancy between the two state vectors 14, 16, then memory areas continue to be allocated by the application even though they are no longer needed by this application and cannot be freely assigned for other processes. This resource problem needs to be eliminated, since it can otherwise result in serious consequential errors. Thus, one alternative is just to output the status of the system in terms of the operating means and to leave the choice of further action to the user. Another option is either to shut down all other existing processes, automatically or likewise after processing an interactive user input, in order then to reboot the entire system or to take predetermined repair measures which unblock the locked memory areas again. This can be done using, by way of example, approaches which are known from “garbage collection”.

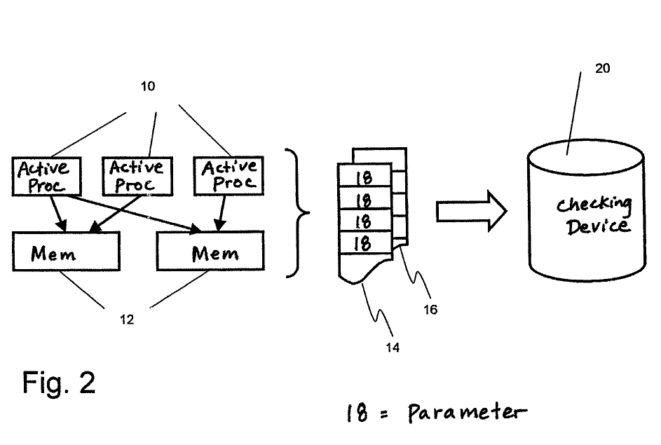

As FIG. 2 shows, a plurality of processes 10 access various operating means, in particular the memory 12. Depending on the state of the system, state vectors 14, 16 specifically stipulating the operating means status for each process are generated at different times. The data for these state vectors 14, 16 are supplied to an operating means checking device 20 which analyzes whether the crash by the process 10 allowed unassignable operating means 10 to arise.

It is also possible to supply the data of the operating means checking device 20 to a device (not shown) which automatically finds the blocked memory areas 12 and makes them available or unblocks them again.

The memory 12 can be a virtual and/or physical memory and/or a main memory and/or a background memory and/or other parts of the address space.

In one advantageous embodiment, the type of access to the memory 12 (read, write, execute) and/or other additional information is also recorded with the state vectors 14, 16.

The invention has been described in detail with particular reference to preferred embodiments thereof and examples, but it will be understood that variations and modifications can be effected within the spirit and scope of the invention.

What is claimed is:

1. A method for ascertaining an assignability of at least one operating means in a computer system after at least one process accessing the operating means has stopped, comprising:
preparing a first state vector for the operating means before the process is put into operation,
preparing a second state vector for the operating means after the process has stopped, and
comparing the first and second state vectors for discrepancies in order to ascertain whether the stopping of the process has resulted in unassignable operating means.

2. The method as claimed in claim 1, wherein the operating means is a shared operating means.

3. The method as claimed in claim 1, wherein the operating means is a memory.

4. The method as claimed in claim 1, wherein the process is a user process.

5. The method as claimed in claim 1, wherein stopping arises as a result of unintentional termination of the process.

6. The method as claimed in claim 1, wherein the two state vectors each comprise a plurality of parameters which relate to the assignability of the at least one operating means.

7. The method as claimed in claim 1, wherein
the operating means is a memory, and
the state vectors are selected from the group consisting of amount of memory used, address of used memory portion, and identification of portion of memory that is available.

8. The method as claimed in claim 1, wherein at least one of the first state vector and the second state vector records, using a process identifier, the process which is accessing the operating means.

9. The method as claimed in claim 1, wherein the method takes into account at least one of all physical operating means and all virtual operating means.

10. The method as claimed in claim 1, wherein some of the operating means are taken into account, in particular the shared operating means.

11. The method as claimed in claim 1, wherein at least one of the first state vector and the second state vector is recorded by testing an operating system service.

12. A method for unblocking an operating means in a computer system after termination of a process, comprising:
preparing a first state vector for the operating means before the process is put into operation,
preparing a second state vector for the operating means after the process has stopped,
comparing the first and second state vectors for discrepancies in order to ascertain whether the stopping of the process has resulted in unassignable operating means,
rebooting the process if the first and second state vectors match, and
starting at least one mechanism for unblocking the operating means if the first and second state vectors do not match.

13. The method as claimed in claim 2, wherein the operating means is a memory.

14. The method as claimed in claim 13, wherein the process is a user process.

15. The method as claimed in claim 14, wherein stopping arises as a result of unintentional termination of the process.

16. The method as claimed in claim 15, wherein the two state vectors each comprise a plurality of parameters which relate to the assignability of the at least one operating means.

17. The method as claimed in claim 16, wherein
the operating means is a memory, and
the state vectors are selected from the group consisting of amount of memory used, address of used memory portion, and identification of portion of memory that is available.

18. The method as claimed in claim 17, wherein at least one of the first state vector and the second state vector records, using a process identifier, the process which is accessing the operating means.

19. The method as claimed in claim 18, wherein the method takes into account at least one of all physical operating means and all virtual operating means.

20. The method as claimed in claim 19, wherein some of the operating means are taken into account, in particular the shared operating means.

21. The method as claimed in claim 20, wherein at least one of the first state vector and the second state vector is recorded by testing an operating system service.

23. A method of assessing a memory after a program has unintentionally stopped, comprising:
preparing a first state vector for the memory before the program is put into operation,
preparing a second state vector for the memory after the program has stopped, and
comparing the first and second state vectors for discrepancies in order to ascertain whether the stopping of the process has resulted in an unassignable memory portion.

24. A method as claimed in claim 23, further comprising:
restarting the process if the first and second state vectors match, and
rebooting an operating system if the first and second state vectors do not match.

25. A computer readable medium storing at least one program for controlling a computer to perform a method of assessing a memory after a program has unintentionally stopped, the method comprising:
preparing a first state vector for the memory before the program is put into operation,
preparing a second state vector for the memory after the program has stopped, and
comparing the first and second state vectors for discrepancies in order to ascertain whether the stopping of the process has resulted in an unassignable memory portion.
